(19) United States
(12) Patent Application Publication
(10) Pub. No.: US 2023/0173388 A1
(43) Pub. Date: Jun. 8, 2023

(54) TECHNIQUES FOR SPAWNING ENTITIES IN A VIRTUAL ENVIRONMENT

(71) Applicant: Blizzard Entertainment, Inc., Irvine, CA (US)

(72) Inventors: Cory Stockton, III, Irvine, CA (US); Dan Story, Irvine, CA (US); Joshua Chapman, Irvine, CA (US); Jared Zondler, Irvine, CA (US)

(21) Appl. No.: 18/076,356

(22) Filed: Dec. 6, 2022

Related U.S. Application Data
(60) Provisional application No. 63/286,762, filed on Dec. 7, 2021.

(51) Int. Cl. A63F 13/56; A63F 13/73; A63F 13/35

(52) U.S. Cl. CPC A63F 13/56; A63F 13/73; A63F 13/35

(57) ABSTRACT

A system is described for weighting and evaluating potential spawn locations by sampling player position to determine a general direction and velocity of travel, thereby allowing the game to favor placing spawns along the player's projected path. In addition, techniques are provided where a game server provides a client a signature value to seed a deterministic pseudorandom number generator to spawn an object at the client. When the client wishes to communicate a player interaction to the server, it transmits the operation the player wants to perform and the identifying information it was originally given. The server uses this data and re-compute the signature using a secret key. If the signature values match, then the server knows the spawn ID and the signature value are legitimate.

### BENEFIT CLAIM

This application claims the benefit under 35 U.S.C. § 119(e) of provisional application 63/286,762, filed Dec. 7, 2021, by Cory Stockton et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### FIELD OF THE INVENTION

The present invention relates to virtual environments and, more specifically, to improved techniques for spawning entities in virtual environments.

### BACKGROUND

The gameplay of many electronic games takes place in virtual environments. Virtual environments may be as complex as densely-populated 3D photo-realistic landscapes and as simple as a sparsely-populated 2D board. The things with which virtual environments are populated include permanent features and temporary features. Examples of permanent features include a virtual shop in a virtual village of the virtual environment, or a tree in a virtual forest of the virtual environment. Such features are considered permanent because they always appear in the same location within the virtual world, and typically cannot be moved or destroyed.

In contrast to permanent features, temporary features are not necessarily always in the same place within the virtual environment, and it may be possible to move, destroy and/or consume them. Examples of entities that can be consumed/destroyed include but are not limited to:
Certain non-playing characters (NPCs)
Certain inanimate objects (e.g. trees that can be harvested, treasure chests, ore deposits that can be mined, etc.)
Certain animate objects (enemies, monsters, etc.)

Typically, temporary entities that are destroyed/consumed in a virtual environment are not gone forever. Often, they will reappear within the virtual environment after a certain amount of time. Thus, one may repeatedly “harvest wood” or “kill spiders” within a virtual environment without ever reaching a situation where all trees and/or spiders have gone extinct within the virtual environment.

When a virtual environment includes temporary entities that may be destroyed/consumed, it is often necessary to provide a way of repopulating the virtual world with additional temporary entities. For example, if a game involves gathering wood by chopping down trees in a virtual forest, the game would become unusable once all trees were cut down and no new trees appeared. Similarly, a game that involves defeating enemies would become unusable if all initial enemies were defeated an no new enemies appeared.

The process of creating a new temporary entity in a virtual environment is referred to as “spawning” an entity. The techniques used to spawn entities within virtual environments of games may have a significant impact on the playability and security of the games. For example, assume that a game requires a user to kill 100 spiders in a virtual environment. The initial population of spiders in the virtual environment may be limited to 20, so as to not overwhelm the user. After the initial 20 spiders are killed, an additional 20 may be spawned. However, without intelligent spawning techniques, the next 20 spiders may be spawned in a location within the virtual environment that is so far from the user's current position in the virtual environment that finding the next batch of spiders may be tedious and frustrating.

The problem of selecting an appropriate spawning location within a virtual environment is particularly critical for location-based virtual environments, where the player's location in the virtual world is dictated by the user's location in the real-world (as detected, for example, by a GPS). A user will tire quickly of a game in which a “kill 50 spiders” quest can only be completed by travelling several miles in the real world to get to a corresponding location in the virtual world where spiders have been spawned.

When a client/server computer architecture is used to provide a virtual environment, the process of spawning temporary entities may jeopardize either the responsiveness or the integrity of the game. For example, if the spawning of temporary entities is handled entirely on the client-side, the spawning is subject to user tampering that may jeopardize the integrity of the game. For example, a sophisticated user may hack the client-side program or data to cause hundreds of treasure chests to spawn near the user's character.

To avoid such client-side tampering, all spawning may be handled on the server-side, where the server merely informs the client about what is spawned and where. While this may resolve the security issue, it may lead to poor performance. For example a final battle in which enemies are spawned at a high rate, the gameplay may seems jumpy or even unplayable if the client has a slow or unreliable connection with the server.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a diagram that illustrates how, in a geolocation-based virtual environment, candidate spawn locations can be weighted during the spawn-location selection process based on a current location and direction of a user, according to an embodiment; and

FIG. 2 is a block diagram of a computing device upon which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Directional Spawning Overview

As explained above, gameplay experience may be severely affected by the spawn-location selection process. Badly selected spawn locations may make a game tedious. This is particularly true in games with location-based virtual environments, where bad spawn-location selection may require the user to travel long distances in the real-world. Further, even when a selected spawn-location is close (in the virtual world) to the virtual world location that corresponds to the real-location of a user, the user will still “miss” the spawned entities if the user is travelling away from the selected spawn location.

Certain game content may require encounters (“spawns”) be personalized for each player. In a geolocation-based game, placing these spawns in a convenient location is of paramount importance: since the designer is asking the player to physically move in the real world to access the content, inaccessible or inconveniently placed spawns may cause the player to become discouraged or quit.

To address this issue, a system is described hereafter for weighting and evaluating potential spawn locations by sampling player position to determine a general direction and velocity of travel, thereby allowing the game to favor placing spawns along the player's projected path.

### Directional Spawning Details

Assume a standard client-server game model: the client (a player's cell phone or tablet) can access GPS information to determine its location and communicate with a networked game server to both report its location and request a “fetch” of its local area, including fixed spawns shared by all players, player-placed objects that may be visible to other players, personalized content created specifically for that player, and other information that collectively makes up the player's experience of the game world.

When the client requests a fetch of the game world, it sends its current local position (expressed as latitude/longitude) to the server along with a heading, computed by trend analysis from GPS samples derived over a time interval. (Many well-known algorithms exist for computing this type of predicted heading, and the specifics of this implementation are irrelevant to the game function.) The server then incorporates this information as a weighting factor when determining the suitability of any individual point for placement of personalized content, with points closer to the player's heading weighted favorably and those opposite the direction of travel weighted unfavorably.

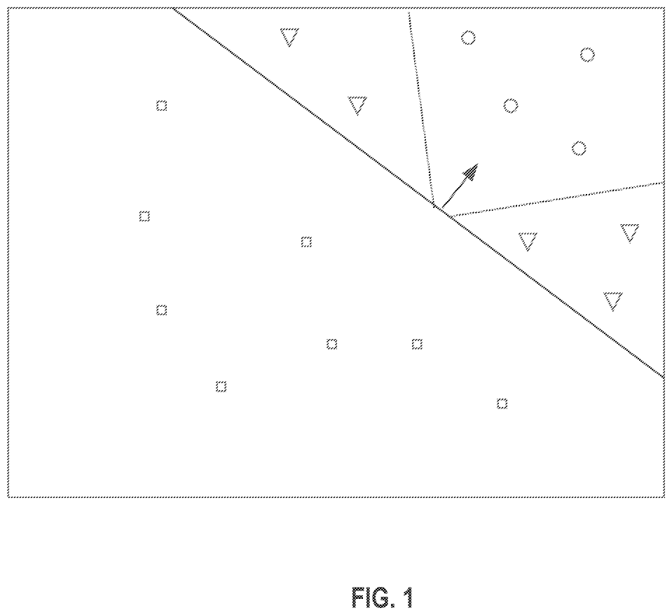

Referring to FIG. 1, it illustrates an example evaluation of various spawn-point candidates in a virtual environment, according to an embodiment. In the example illustrated in FIG. 1, squares represent points that are negatively weighted, triangles represent points that are neutral, and circles represent points that are positively weighted.

Let θ_{S} and L_{S} represent the latitude and longitude of the point under consideration, and θ_{P}, L_{P} and β represent the position and bearing of the player. The directional variance d of the point is calculated as follows:

d=|atan 2(θ_{S}−θ_{P},L_{S}−L_{P})−β|

And the applied weighting w is then calculated using constants c and f which the game designer can tune to adjust the sensitivity and relative weight applied to directionality for a given piece of content.

$$w = \frac{{d}^{c}}{{( \frac{π}{2} )}^{c}} \cdot f$$

Other weighting factors (such as distance, type of point, or presence of nearby hazards like highways) may also be applied to determine the final placement of objects. In certain situations, all points along the player's path may be deemed unsuitable for other reasons, and non-optimal points may be used instead. (For example, if the player's path is leading into a designated restricted area such as a military base or graveyard.) Points deemed unsuitable for personalized content may be used for other types of content considered lower priority, as well.

Once an object has been placed, the server retains the placement information so that subsequent data fetches will return the object in a consistent location so long as it remains valid. If the player changes heading or direction, new objects may be placed along their path, but formerly placed ones will remain in position so long as they remain valid for gameplay.

### Overview of Client-Based Procedural Content Generation with Cryptographic Verification

As explained above, procedural content generation in online games suffers from a core trade-off of security, expense and gameplay experience. If the client does content generation, it can be fast and cheap, but it is inherently untrustworthy and can be manipulated by a malicious actor. If the server does generation, it is either expensive (in both computation and bandwidth costs), or it is slow: if every piece of content the player could interact with must be fully generated and sent across the network in case the player does interact with it, the server must pay the resource cost for many things that will only be seen but never fully utilized. An alternative would be to generate a skeletal set of data for every possible object, then request more information if the player attempts to interact with it; this, however, requires a round-trip network request to the server, making the player wait and significantly degrading their gameplay experience, especially on mobile devices where unstable wireless connections can result in roundtrip times reaching into multiple seconds.

In the following section, techniques are described that attempt to balance these competing demands by performing a minimal amount of content generation on the server and offloading the rest to the client in a way that can be securely verified at a later point in time.

### Details of Client-Based Procedural Content Generation with Cryptographic Verification

Suppose a game allows a player to wander an open environment with randomly placed objects consisting of creatures (both friendly and hostile), interactive objects (such as treasure chests) and environmental/decorative scenery (such as trees). For a given arbitrary point in the world, at a given time, the content generation algorithm can follow a set of probabilistic rules to determine what should occupy the location and for how long. Additionally, some objects may have associated individualized rewards: while the basic type of an object is the same for all players (if the algorithm decides a particular point is occupied by a treasure chest, all players see a treasure chest), the associated rewards (such as the treasure inside) can differ.

If the server performs all generation, it may hide the logic from the player and produce an unpredictable outcome within the probabilistic constraints specified by the design rules. However, this work is computationally expensive in aggregate (e.g. a single server may have to concurrently compute and communicate all object generation/spawning decisions for thousands of users) and the additional details for each object may constitute a considerable amount of extra data that must be sent across the network.

This can be mitigated by pre-emptively giving the client a copy of the generation rules and data, allowing it to generate content on demand and offloading the computational work to the player's computing device (the “client device). This not only reduces the burden on the server but provides more responsiveness to the player: their device does not need to either receive and process large amounts of information for objects the player will never interact with, nor does it need to wait for a network round-trip to request additional information on each point the player does wish to interact with.

The fact that the rules are known to the client, however, opens a significant security issue: if the client can determine what will spawn at a specific location at a specific time—or even worse, control the spawn locations—a malicious actor could use those rules to predict what would be generated, and “fish” for an outcome that is of greater benefit to the player, allowing intentionally rare content to be encountered with high frequency.

This security issue can be nullified if the server also generates a random seed value unique to each player for each point: the common data can be used to determine the object type, while the individualized data is used to determine the specific characteristics. The server's generation process can be hidden from the client, preventing prediction.

This, then, leads to a third problem: how to ensure that the seed value the client used to hydrate the record was in fact legitimate. The naïve approach would be to store every possible combination of spawn point and seed that the server generated and then retrieve them later; this would quickly lead to data storage costs spiraling out of control, as a single player wandering around for a short time may generate hundreds or thousands of possible spawns.

To resolve this problem, a hash message authentication code (HMAC) can be introduced. (Numerous cryptographic algorithms are suitable for this purpose and the most suitable implementation will vary from game to game.) The server can use the combination of the unique identifier of the spawn, the unique identifier of the player, and a secret key unknown to the client to produce a signature. The client may then supply the signature along with the spawn identifier when interacting with the spawn, proving to the server that the original identifier was not tampered with. Better still, if there is variation in the inputs, a properly distributed hash function will produce an HMAC value that is itself random and unpredictable, providing the necessary seed value for individualized population.

Thus, the game server can send three pieces of information about each point it generates to the client:

| Field | Description |
|---|---|
| Spawn ID | Uniquely identifies the object, its type, and its longevity |
| Location | Coordinates of the object in the game world |
| Signature | Authentication code computed from the spawn ID, location, |
| | the player's ID, and a secret key |

When a client wants to display the spawn to the player, it uses a deterministic hydration algorithm and data set previously agreed upon by both client and server, using the signature value to seed a deterministic pseudorandom number generator and proceeding to generate all other attributes of the object. When it wishes to communicate a player interaction to the server, it transmits the operation the player wants to perform and the identifying information it was originally given: the unique ID and location of the object in question and the signature. The server can then take this data and re-compute the signature using the secret key. If the signature values match, the spawn ID and the signature value are legitimate.

The server can then repeat the same generation process the client did to hydrate the spawn, using the signature value as its random seed. The server will never need to perform this operation on the vast majority of objects in the game world—only on objects the player interacts with—saving considerable computational resources, and since none of this additional data must be sent between client and server, bandwidth costs are also considerably reduced on a per-spawn basis.

Once generation is complete, the server can perform the operation the client requested against its copy of the object. So long as the client and server's generation rules and data match, it should arrive at the same result as the client (which can be verified by computing a hash of the player's overall state at the end of the operation) and the player can proceed with security intact.

As described above, one implementation makes use of three parameters:
Spawn ID
Location
Signature

Specifically, the algorithm described uses Spawn ID, the Location and the unique ID for the player to create and validate the signature in order to provide security. However, since HMAC does not require a particular input size, alternative implementations can adjust the inputs to the algorithm based on gameplay requirements.

For example, one implementation could ignore the location sent if the precise location data isn't useful for any server-side processing. In a similar vein, an implementation can add “metadata” about the spawn that can be generated by the original server creating the spawns and validated when the spawn is later used in a safe way as it is part of the cryptographic signature.

### Preventing Replay Attack

A malicious actor may attempt to reuse a legitimate identifier and signature for an interaction that is no longer valid (known as a “replay attack”). (For example, attempting to open and loot the same treasure chest twice.) This can be mitigated by adding an expiration date into the signed envelope, either as an additional field or by encoding it into a subset of bits of the unique identifier. The server can then store a log of the interactions the player has performed and use it as a check against a replay. When the spawn reaches its expiration date and can no longer be the subject of valid interactions, its relevant log entries may be deleted to conserve storage.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

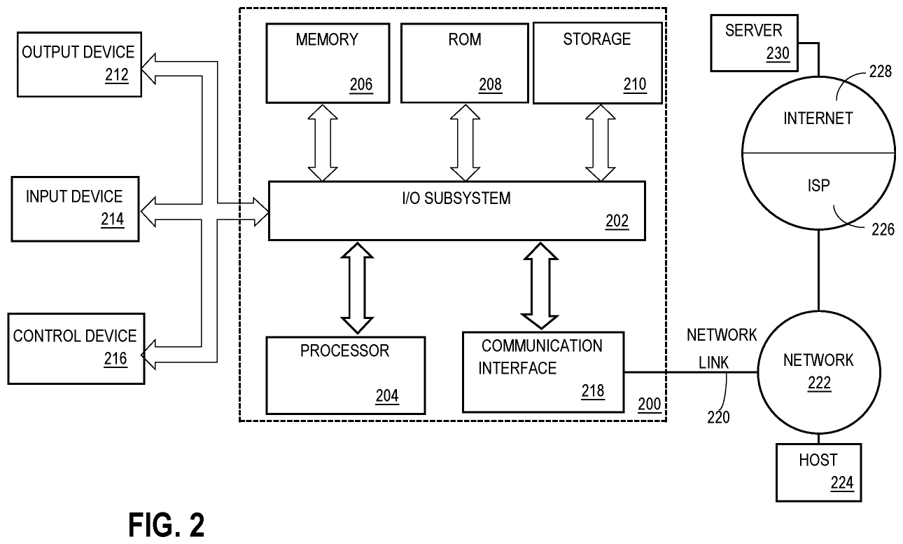

For example, FIG. 2 is a block diagram that illustrates a computer system 200 upon which an embodiment of the invention may be implemented. Computer system 200 includes a bus 202 or other communication mechanism for communicating information, and a hardware processor 204 coupled with bus 202 for processing information. Hardware processor 204 may be, for example, a general purpose microprocessor.

Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk, optical disk, or solid-state drive is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

Computer system 200 may implement the techniques described herein using customized hard-wired logic, one or more ASICs or FPGAs, firmware and/or program logic which in combination with the computer system causes or programs computer system 200 to be a special-purpose machine. According to one embodiment, the techniques herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 210. Volatile media includes dynamic memory, such as main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media may be involved in carrying one or more sequences of one or more instructions to processor 204 for execution. For example, the instructions may initially be carried on a magnetic disk or solid-state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
sampling real-world positions of a human user that is a player in a game world;
based on the real-world positions, determining a general direction and velocity of travel;
based on the general direction and velocity of travel, determining a projected path of the player in the game world; and
selecting a location for one or more spawn events within the game world based, at least in part, on the projected path of the player.

2. The method of claim 1 wherein sampling real-world positions comprises obtaining, at a server associated with the game world, from a GPS unit on a computing device of the human user, latitude/longitude of the human user over a time interval.

3. The method of claim 2 wherein determining a general direction and velocity of travel includes computing, by trend analysis, a predicted heading of the human user based on the latitude/longitude of the human user over the time interval.

4. The method of claim 1 wherein selecting the location for one or more spawn events includes using the projected path of the player in the game world as a weighting factor, with points closer to the projected path of the player being weighted favorably, and points opposite the projected path of the player being weighted unfavorably.

5. The method of claim 1 wherein selecting the location includes:
determining whether points along the projected path are unsuitable, and
weighting unfavorably those points that are unsuitable.

6. A method comprising:
sending, from a game server to a client device, information that includes at least:
a spawn ID that identifies an object, and
an authentication code;
based on the authentication code, hydrating a spawn of a first copy of the object in a game world displayed on the client device;
sending, from the client device to the game server, information that includes at least:
an indication of a player interaction,
the spawn ID, and
the authentication code;
at the game server, determining whether the authentication code received from the client device matches a recomputed authentication code; and
responsive to the authentication code matching a recomputed authentication code, the game server performing an operation, associated with the player interaction, on a second copy of the object at the game server.

7. The method of claim 6 wherein hydrating a spawn of a first copy of the object based on the authentication code includes using the authentication code to seed a deterministic pseudorandom number generator that is used to hydrate the spawn of the first copy of the object.

8. The method of claim 6 wherein the information sent from the game server to the client, and the information sent from the client to the game server, both include a location that indicates coordinates of the object in the game world.

9. The method of claim 6 further comprising the game server computing the recomputed authentication code based on at least the spawn ID and a secret key.

10. The method of claim 6 further comprising the game server computing the recomputed authentication code based on at least the spawn ID, a player ID associated with a user of the client device, and a secret key.

11. The method of claim 6 further comprising the game server hydrating a spawn of the second copy of the object by using the authentication code as a seed to a deterministic pseudorandom number generator.

12. The method of claim 6 wherein:
the information sent from the game server to the client, and the information sent from the client to the game server, both include and expiration time; and
the game server only performs the operation if the expiration time has not been reached.

13. One or more non-transitory computer-readable media comprising storing instructions which, when executed by one or more computing devices, cause:
sampling real-world positions of a human user that is a player in a game world;
based on the real-world positions, determining a general direction and velocity of travel;
based on the general direction and velocity of travel, determining a projected path of the player in the game world; and
selecting a location for one or more spawn events within the game world based, at least in part, on the projected path of the player.

14. The one or more non-transitory computer-readable media of claim 13 wherein sampling real-world positions comprises obtaining, at a server associated with the game world, from a GPS unit on a computing device of the human user, latitude/longitude of the human user over a time interval.

15. The one or more non-transitory computer-readable media of claim 14 wherein determining a general direction and velocity of travel includes computing, by trend analysis, a predicted heading of the human user based on the latitude/longitude of the human user over the time interval.

16. The one or more non-transitory computer-readable media of claim 13 wherein selecting the location for one or more spawn events includes using the projected path of the player in the game world as a weighting factor, with points closer to the projected path of the player being weighted favorably, and points opposite the projected path of the player being weighted unfavorably.

17. The one or more non-transitory computer-readable media of claim 13 wherein selecting the location includes:
determining whether points along the projected path are unsuitable, and
weighting unfavorably those points that are unsuitable.

18. A one or more non-transitory computer-readable media storing instructions which, when executed by one or more computing devices, cause:
sending, from a game server to a client device, information that includes at least:
a spawn ID that identifies an object, and
an authentication code;
based on the authentication code, hydrating a spawn of a first copy of the object in a game world displayed on the client device;
sending, from the client device to the game server, information that includes at least:
an indication of a player interaction,
the spawn ID, and
the authentication code;
at the game server, determining whether the authentication code received from the client device matches a recomputed authentication code; and
responsive to the authentication code matching a recomputed authentication code, the game server performing an operation, associated with the player interaction, on a second copy of the object at the game server.

19. The one or more non-transitory computer-readable media of claim 18 wherein hydrating a spawn of a first copy of the object based on the authentication code includes using the authentication code to seed a deterministic pseudorandom number generator that is used to hydrate the spawn of the first copy of the object.

20. The one or more non-transitory computer-readable media of claim 18 wherein:
the information sent from the game server to the client, and the information sent from the client to the game server, both include and expiration time; and
the game server only performs the operation if the expiration time has not been reached.
